(19) United States
(12) Patent Application Publication
(10) Pub. No.: US 2026/0107137 A1
(43) Pub. Date: Apr. 16, 2026

(54) METHOD AND APPARATUS FOR NETWORKING A BLUETOOTH MESH NETWORK

(71) Applicant: TP-Link Systems Inc., IRVINE, CA (US)

(72) Inventors: Yuwei QIU, Shenzhen (CN); Tao YANG, Shenzhen (CN)

(73) Assignee: TP-Link Systems Inc., IRVINE, CA (US)

(21) Appl. No.: 18/918,027

(22) Filed: Oct. 16, 2024

(51) Int. Cl. H04W 12/047; H04B 17/318; H04W 12/61

(52) U.S. Cl. CPC H04W 12/047; H04B 17/328; H04W 12/61

(57) ABSTRACT

The present disclosure provides a method of a Bluetooth Mesh network networking method and corresponding devices, the method including: receiving address information of a device to-be-networked, by a networking device, from the device to-be-networked accessing a first network based on a first key; determining whether the address information is available for the device to-be-networked; and in response to the address information being available for the device to-be-networked, transmitting a second key for the Bluetooth Mesh network to the device to-be-networked via the first network for the device to-be-networked to access the Bluetooth Mesh network, wherein the networking device is in both the first network and the Bluetooth Mesh network.

### TECHNICAL FIELD

The present disclosure relates to the field of wireless local area networks, and in particular, to a method, apparatus, and computer-readable storage medium for Bluetooth Mesh network networking.

### BACKGROUND

The Bluetooth Mesh network is an emerging application of Bluetooth technology that builds on Bluetooth, which utilizes a one-to-many mesh network topology to achieve broader connectivity coverage. The mesh network allows devices to be interconnected to form a self-organizing, self-healing network. There is still a need for a more efficient and flexible Bluetooth Mesh network networking method and corresponding apparatus.

### SUMMARY

The present disclosure proposes a method for Bluetooth Mesh network networking and apparatus performing the same.

In accordance with an aspect of the present disclosure, there is provided a Bluetooth Mesh network networking method, including: accessing a first network, by a device to-be-networked based on a first key; receiving, from a networking device via the first network, a second key for accessing the Bluetooth mesh network; and accessing the Bluetooth Mesh network based on the second key, wherein the networking device is in both the first network and the Bluetooth Mesh network.

In one embodiment, a device(s) in the first network and/or the Bluetooth Mesh network may act as a relay node relaying communication between the device to-be-networked and the networking device. In specific embodiments, a device(s) in the first network may act as a relay node relaying communication between the device to-be-networked and the networking device under the first network, a device(s) in the Bluetooth Mesh network may act as a relay node relaying communication between the device to-be-networked (and the device networked already) and the networking device under the Bluetooth Mesh network, while the device(s) both in the first network and the Bluetooth Mesh network may act as a relay node relaying communication between the device to-be-networked and the networking device both under the first network and the Bluetooth Mesh network

In one embodiment, the method further comprises, after accessing the Bluetooth Mesh network, the device to-be-networked remaining in the first network.

In accordance with an aspect of the present disclosure, there is provided a Bluetooth Mesh network networking method, including: a networking device receiving, from a device to-be-networked that accesses a first network based on a first key, address information of the device to-be-networked; determining whether address information is available for the device to-be-networked; and transmitting, to the device to-be-networked, the second key for accessing the Bluetooth Mesh network via the first network in response to the address information being available for the device to-be-networked, wherein the networking device is in both the first network and the Bluetooth Mesh network.

In one embodiment, the transmitting, to the device to-be-networked, the second key for accessing the Bluetooth Mesh network further comprises: determining a priority of the device to-be-networked based on at least one of a distance of the networking device from the device to-be-networked and a number of hops required to send a message from the networking device to the device to-be-networked; and transmitting the second key to the device to-be-networked in response to the priority of the device to-be-networked being higher than priority(ies) of other device(s) to-be-networked.

In an embodiment, the distance of the networking device from the device to-be-networked is indicated by received signal strength indication (RSSI) received from the device to-be-networked; and the number of hops required to transmit the message to the device to-be-networked is indicated by time-to-live (TTL) received from the device to-be-networked.

According to an aspect of the present disclosure, there is provided a Bluetooth device, comprising: a transceiver; a memory; and a processor configured to control the transceiver and the memory to perform steps comprising: accessing a first network based on a first key; receiving, from a networking device via the first network, the second key for accessing the Bluetooth mesh network; and accessing the Bluetooth Mesh network based on the second key, wherein the networking device is in both the first network and the Bluetooth Mesh network.

In one embodiment, the Bluetooth device comprises at least one of a smart light system, a downlight, and a switch.

According to an aspect of the present disclosure, there is provided a device for Bluetooth Mesh network networking, comprising: a processor; and a memory having stored thereon computer program which, when executed by the processor, causes the processor to perform the steps of: receiving, from a device to-be-networked accessing a first network based on a first key, address information of the device to-be-networked; determining whether the address information is available for the device to-be-networked; and in response to the address information being available for the device to-be-networked, transmitting the second key for accessing the Bluetooth Mesh network to the device to-be-networked via the first network, wherein the device for Bluetooth Mesh network networking is in both the first network and the Bluetooth Mesh network.

According to an aspect of the present disclosure, there is provided a computer program product having stored thereon computer program which, when executed by a computing device, implements the steps of: receiving, from a device to-be-networked accessing a first network based on a first key, address information of the device to-be-networked; determining whether the address information is available for the device to-be-networked; and transmitting the second key for accessing the Bluetooth Mesh network to the device to-be-networked via the first network in response to the address information being available for the device to-be-networked.

In accordance with embodiments of the present disclosure, a more efficient and flexible approach to Bluetooth Mesh network networking is provided, and further embodiments of the present disclosure may also support remote networking and for some complex networking scenarios, including, for example, scenarios where only new devices at long distances are powered on or where only a small number of more dispersed new devices are powered on.

### BRIEF DESCRIPTION OF DRAWINGS

FIG. 1 schematically shows a method performed by the networking device for Bluetooth Mesh networking according to an embodiment of the present disclosure;

FIG. 2 schematically illustrates a method performed by the device to-be-networked waiting for accessing the Bluetooth Mesh network according to an embodiment of the present disclosure;

FIG. 3 schematically illustrates a flow chart of an inter-device collision address detection method according to an embodiment of the present disclosure;

FIG. 4 schematically illustrates a flow chart of an example of a Bluetooth Mesh networking method according to an embodiment of the present disclosure; and

FIG. 5 schematically illustrates a block diagram of a device according to an embodiment of the present disclosure.

### DETAILED DESCRIPTION

Before undertaking the description of the Detailed Description below, it may be advantageous to set forth definitions of certain words and phrases used throughout this patent document. The terms “transmit”, “receive”, and “communicate”, as well as derivatives thereof, encompass both direct and indirect communication. The terms “include” and “comprise” as well as derivatives thereof, mean inclusion without limitation. The term “or” is inclusive, meaning and/or. The phrase “at least one of”, when used with a list of items, means that different combinations of one or more of the listed items may be used, and only one item in the list may be needed.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read-Only Memory (ROM), Random Access Memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It should be understood that the terms “first”, “second” and the like, as used in this disclosure, do not denote any order, quantity, or importance, but are merely used to distinguish one component from another. The singular forms “a”, “an”, “the” and the like do not denote a limitation of quantity, but rather denote the presence of at least one, unless the context clearly dictates otherwise.

Various embodiments used to describe the principles of the present disclosure in this patent document, discussed below, are by way of illustration only and should not be construed in any way to limit the scope of the disclosure.

The following description with reference to the accompanying drawings is provided to assist in comprehensive understanding of various embodiments of the present disclosure as defined by the claims and their equivalents. This description includes various specific details to assist in that understanding but is to be regarded as exemplary only. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

Unless defined differently, all terms (including technical terms or scientific terms) used in the present disclosure have the same meanings understood by those skilled in the art to which the present disclosure belongs. Generally, terms as defined in a dictionary are interpreted to have a meaning consistent with a context in the relevant technical field, and should not be interpreted ideally or excessively formally unless clearly defined as such in the present disclosure.

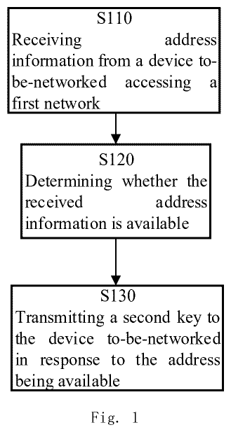

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Bluetooth Mesh networks are an emerging application of Bluetooth technology with the following features: (1) multi-hop routing: data sent by networking devices can continue to be transmitted through intermediate devices, extending the range of the networking; (2) network self-organization and self-healing: gateways in the network can automatically discover and connect to new devices, while also being able to re-network when the device(s) fail; (3) strong scalability: a large number of devices can be accommodated in the network, the network size can be very large.

This Bluetooth Mesh network networking process generally relies on the performance of a cellphone or gateway acting in the role of a networking device or provisioner utilizing a PB-GATT (Bluetooth connection-based) or PB-ADV (Bluetooth broadcast-based) mechanism, in which, the provisioner must be within Bluetooth communication range of the device to be provisioned onto the network (pre-provisioning object). One way to solve this problem is to adopt the remote provisioning introduced by the Bluetooth Mesh 1.1 standard. However, the remote provisioning function has limitations such as weak robustness, limited flexibility, and difficult application.

In view of this, the present disclosure proposes a method for Bluetooth Mesh network networking and devices performing the same.

The present disclosure relates to the functionality of Bluetooth Mesh1.0 and utilizes the following capabilities of the Bluetooth Mesh network: (1) two devices in the Bluetooth Mesh network can maintain stable communication within a certain distance. (2) a device in the Bluetooth Mesh network can forward a packet in the Bluetooth Mesh network as a relay station if its relay function is turned on, thereby effectively enlarging a communicable distance among the devices in the network. (3) messages in the Bluetooth Mesh network can be accompanied by other information, greatly enhancing the flexibility and subsequent scalable potential of the system.

In the Bluetooth Mesh network networking method according to an embodiment of the present disclosure, a two-stage networking is adopted: a device to-be-networked accesses a first network using a default key first, and then receives a key for accessing a Bluetooth Mesh network from a networking device which is simultaneously in the first network and the Bluetooth Mesh network via the first network after permission from the networking device is obtained, thereby accessing the Bluetooth Mesh network. Wherein the permission from the networking device may be a permission of the networking device to address information transmitted by the device to-be-networked. During the networking process, communication of the networking device with the device to-be-networked can be relayed by using other devices that have been networked as a relay device, thereby effectively expanding the communicable distance between the networking device and the device to-be-networked, so that a device to-be-networked that is distant can also be added to the Bluetooth Mesh network.

The method according to embodiments of the present disclosure can efficiently and flexibly add a new device to-be-networked to the Bluetooth Mesh network while guaranteeing normal communication among provisioned devices (i.e., devices already-networked) and the networking device, and furthermore, the present disclosure can quickly, batchwise, and stably add a new device and/or a distant device.

FIG. 1 schematically illustrates a method performed by a networking device for a Bluetooth Mesh network according to an embodiment of the disclosure.

In step S110, the networking device 100 receives address information of the device to-be-networked 200 from the device to-be-networked 200 accessing the first network based on the first key.

Through this step, the device to-be-networked 200 first accesses the first network using its existing first key and establishes communication with the networking device to send its own address information, so that the networking device 100 can thereby know the existence of the device to-be-networked 200 and identify the device to-be-networked by its address information.

In one embodiment, the networking device 100 may be implemented as a user-side control device. In a more specific embodiment, the networking device may be implemented in the form of specialized application or software running on the user-side control device. While the device to-be-networked may be implemented as a Bluetooth device such as a smart light system, a downlight, a switch, and the like, which are expected to access a Bluetooth Mesh network (which may also be referred to below as “formal Bluetooth Mesh network”, also simply “formal network”).

The first network here may also be referred to as a temporary Bluetooth Mesh network (which may also be referred to herein simply as temp network), while the first key is a key for accessing the first network. Optionally, the first key may include a network layer sub-key and an app layer sub-key. In a non-limiting embodiment, these two sub-keys may be fixed and labeled as: temp_net_key and temp_app_key, respectively. The temp_net_key and temp_app_key may be factory default settings of the device. That is, the device to-be-networked 200 is set with the first key by default at the time of manufacture. Thus, upon power-up, the device to-be-networked can access the first network using the first key.

In one embodiment, the networking device 100 may broadcast a probe message in the temp network in a timely manner, with nothing attached to the message field of the probe message. This message is for probing a device(s) in the temp network and gathering information about a device(s) to-be-networked.

The device to-be-networked 200 accessing the first network based on the first key replies to a device status (device_status) message in response after listening to the probe message. Alternatively, the device status message may be address information of the device, for example, the message field of the device_status message may contain:
occupied Unicast Address
the device's own unique Bluetooth MAC address

That is, the address information received by the networking device 100 from the device to-be-networked 200 may include the unicast address occupied by the device to-be-networked 200 and the unique Bluetooth MAC address of the device to-be-networked 200 itself. Wherein the unicast address may be obtained by the device to-be-networked in various suitable ways, such as, by way of non-limiting example, the device to-be-networked may generate and occupy the unicast address in a hash function according to its own Bluetooth MAC address upon power-up.

In step S120, the networking device 100 determines whether the address information it receives from the device to-be-networked 200 is available for the device to-be-networked 200.

In the Bluetooth Mesh network, the networking device needs to communicate with the device to-be-networked 200 based on the unicast address information of the device to-be-networked 200. However, when there are a plurality of devices accessing the first network, there may be a situation where both at least one of the plurality of devices and the device to-be-networked 200 attempt to occupy the same unicast address, and thus requiring the networking device 100 to verify the unicast address in the address information sent by the device to-be-networked to determine whether the associated unicast address is available for the device to-be-networked 200.

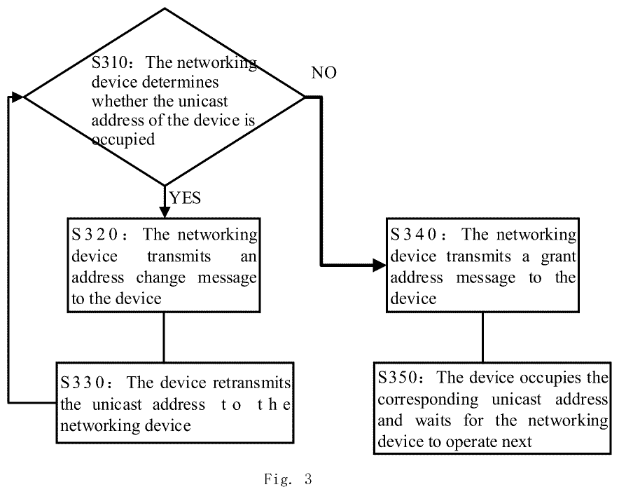

The inter-device collision address detection according to an embodiment of the present disclosure is schematically illustrated in FIG. 3, in conjunction with which an inter-device collision address detection process according to an embodiment of the present disclosure is explained below.

In FIG. 3, the networking device 100 determines whether the unicast address of the device to-be-networked is occupied in step S310. If the unicast address occupied by the current device to-be-networked is already occupied before, the networking device looks for an available unicast address(es) and transmits a change address message to the current device to-be-networked either directly or via the relay device in step S320. In one embodiment, when the networking device determines that the unicast address of the device to-be-networked is in the list of unicast addresses occupied by the device already networked, it transmits a message to the device to-be-networked asking it to change its unicast address, which may include a currently unoccupied unicast address for the device to-be-networked to select and use. In a further embodiment, the change address message may be a change_addr message, in particular, the change_addr message may contain:
Avaiable Unicast Address(es)
Bluetooth MAC address of the current device to-be-networked

If the unicast address occupied by the current device to-be-networked is not occupied before, the networking device transmits a grant address message for confirming the corresponding unicast address to the current device to-be-networked directly or via the relay device in step S340. In one embodiment, the grant address message may be an admit_addr message. Specifically, the admit_addr message may contain:
Unicast address confirmed as being available for the device to-be-networked
Bluetooth MAC address of the device to-be-networked

In this way, the networking device may send different messages to the device to-be-networked based on whether the address information of the device to-be-networked is available for the device to-be-networked.

Returning to FIG. 1, in step S130, the networking device 100 transmits the second key for accessing the Bluetooth Mesh network to the device to-be-networked 200 via the first network in response to the address information being available for the device to-be-networked.

After confirming that the unicast address of the device to-be-networked is available, the networking device may use the unicast address to communicate with the device to-be-networked during subsequent communication, including transmitting the second key to the device to-be-networked so that the device to-be-networked 200 can access the Bluetooth Mesh network using the second key.

In one embodiment, the second key may be sent to the device to-be-networked in consideration of whether the device to-be-networked 200 is ready for provision.

In one specific embodiment, the networking device 100 will broadcast a ready-to-provision (ready_prov) message, the message field of which is used to probe the temp network for device to-be-networked that have entered the temp network and for which unicast addresses are confirmed to be available, thereby collecting information of these devices.

After the networking device 100 collects the provision status (prov_status) message of the device to-be-networked 200 entering the temp network, the networking device 100 confirms that the device to-be-networked 200 is available for provision based on the message, and transmits a provision (prov) message including the second key to the device to-be-networked 200. The message field in the prov message may include:
Formal_net_key as a network layer sub-key of the second key
Formal_app_key as an application layer sub-key of the second key

In a further embodiment, the transmitting of the second key to the device to-be-networked 200 also takes into account other devices waiting in the first network to be added to the formal Bluetooth Mesh network. For example, transmitting the second key for accessing the Bluetooth Mesh network to the device to-be-networked may involve determining a priority of the device to-be-networked based on at least one of a distance of the networking device from the device to-be-networked and a number of hops required to send a message from the networking device to the device to-be-networked; and transmitting the second key to the device to-be-networked in response to the priority of the device to-be-networked being higher than priority(ies) of other device(s) to-be-networked.

In a specific embodiment, the device to-be-networked 200 may include in the prov_status message Received Signal Strength Indication (RSSI) which can indicate the distance between the device to-be-networked 200 and the networking device and Time to live (TTL) which may be used to indicate the number of hops required to send a message from the networking device to the device 200). And the networking device 100 may use a weighted sum of the two parameters of RSSI and TTL in the received prov_status message to determine the priority of the device to-be-networked 200, and send the second key to the device to-be-networked in response to the priority of the device to-be-networked 200 being higher than priority(ies) of other device(s) to-be-networked. It should be noted that other algorithms may also be employed to determine priority

It should be noted that the networking device is in both the first network and the formal Bluetooth Mesh network at all times during the entire communication, so that the networking device can communicate with devices in both networks simultaneously, ensuring provisioning efficiency while ensuring communication with the device already networked.

In one embodiment, the communication of the networking device with the device to-be-networked may be relayed through a relay device, which may be a Bluetooth device that has accessed the Bluetooth Mesh network and remains in the first network. These devices can forward packets in the Bluetooth Mesh network as relay stations when their relay functions are turned on, effectively extending the communicable distance between the networking device and the device to-be-networked.

Alternatively, in the above communication process, the networking device stores in the memory the information communicated with the device to-be-networked and the address information of the current device already networked, such as the address information of the device to-be-networked, the list of occupied unicast addresses, mapping relationship of the unicast addresses of the device already networked to their Mac addresses, and the like. Thus, when communication with the device to-be-networked is interrupted, the communication information can be read from the memory for resuming communication therebetween and continuing the networking process, thereby improving networking efficiency. Even if an abnormal situation (such as packet loss and power loss) occurs midway, communication can be restored by reading the information in the memory.

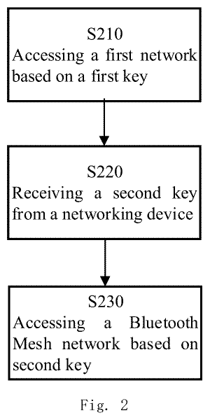

FIG. 2 schematically illustrates a Bluetooth Mesh network networking method performed by a device to be added to the Bluetooth Mesh network according to an embodiment of the present disclosure.

In step S210, the device to-be-networked 200 accesses the first network based on the first key.

As previously described, the first key is a key of the first network, and the device to-be-networked 200 is provided with the first key as a factory default setting, so that the device to-be-networked 200 can automatically access the first network after being powered up.

Specifically, the device to-be-networked 200 may use the same first key as the key held by the networking device (e.g., including temp_net_key and temp_app_key), and generate and occupy a unicast address using a hash function according to its MAC address, and then enter the first network.

In step S220, the device to-be-networked 200 receives the second key for accessing the Bluetooth mesh network from the networking device via the first network.

The device to-be-networked 200, after accessing the first network using its own existing first key, can keep communication with the networking device in the first network, so that it can receive the second key for the Bluetooth Mesh network from the networking device via the first network to achieve Bluetooth Mesh network networking.

In one embodiment, the networking device may send the second key to the device to-be-networked 200 when the device 200 is ready to access the Bluetooth Mesh network.

In particular, the device to-be-networked, upon entering the first network, listens to the probe message broadcast by the networking device 100 in the temp network and replies in response to the networking device 100 with its address information, which may be sent by means of the device_status message as described above. As described earlier with reference to FIG. 3, the networking device 100 may perform the inter-device collision address detection based on the unicast address in the received address information and transmit the detection result to the device to-be-networked 200. With continued reference to FIG. 3, if the networking device 100 transmits the change_addr message to the device to-be-networked requiring it to change its unicast address in step S320, in step S330, the device to-be-networked receives the message from the networking device either directly or via the relay device and determines the Bluetooth MAC address of the device in the message, and if the Bluetooth MAC address in the message field of the message coincides with its own Bluetooth MAC address, the current device to-be-networked retransmits the unicast address based on received available unicast address from the networking device, and re-enters step S310. If the networking device 100 transmits the grant address (admit_addr) message for confirming the corresponding unicast address to the device to-be-networked directly or via the relay device in step S340, the device to-be-networked 200 determines that the Bluetooth MAC address in the message field of the admit_addr message coincides with its Bluetooth MAC address in step S350, and occupies the unicast address for subsequent communication. Specifically, in an alternative embodiment, the device to-be-networked 200 transmits a provision status message (such as the prov_status message as described above) to the networking device 100 indicating it is ready to access the Bluetooth Mesh network in response to receiving a ready-to-provision message, such as the ready_prov message described above.

In another embodiment, transmitting the second key to the device to-be-networked 200 by the networking device takes into account a provision priority of the device to-be-networked 200. The networking device transmits the second key to the device to-be-networked 200 only if its provisioning priority is higher than provisioning priority(ies) of other device(s) to-be-networked. The provisioning priority of the device to-be-networked may be determined based on at least one of the received signal strength indication (RSSI) and the time-to-live (TTL) of the device to-be-networked. For example, the priority may result from a weighted sum of the RSSI and TTL. The RSSI and the TTL of the device to-be-networked may be included in the provision status message as described above.

The usage of the provision priority can guarantee that devices to-be-networked relatively closer to the center of the topology first enter the formal Bluetooth Mesh network, which guarantees the efficiency of initializing distribution parameters in the formal Bluetooth Mesh network, speeding up the overall provision flow.

In step S230, the device to-be-networked 200 accesses the Bluetooth mesh network based on the second key.

The device to-be-networked 200 enters the formal Bluetooth mesh network based on the second key. Upon entering the formal network, the device to-be-networked 200 may communicate with the networking device 100 for heartbeat packet reporting, gateway election, and the like.

Alternatively, during the networking process, the device to-be-networked 200 may be provided with a memory (which may be implemented, for example, as a register) for holding information communicated with the networking device. Specifically, the information may include the message received by the device to-be-networked from the networking device for changing the address, the unicast address acknowledged by the networking device to be available and the second key, and the like. Thus, even if an abnormal situation such as packet loss, power loss occurs midway, the networking device reads the information from its memory for recovery, thereby improving networking efficiency.

To this end, the device to-be-networked stores the first key for accessing the first network and the second key for accessing the Bluetooth Mesh network while being in the first network and the Bluetooth Mesh network, so that it can simultaneously communicate with the device in the first network and the device in the Bluetooth Mesh network. In one embodiment, a commissioning device already in the first network and the Bluetooth Mesh network can only communicate with the device in the first network and the device in the Bluetooth Mesh network at the same time if its relay function is turned on.

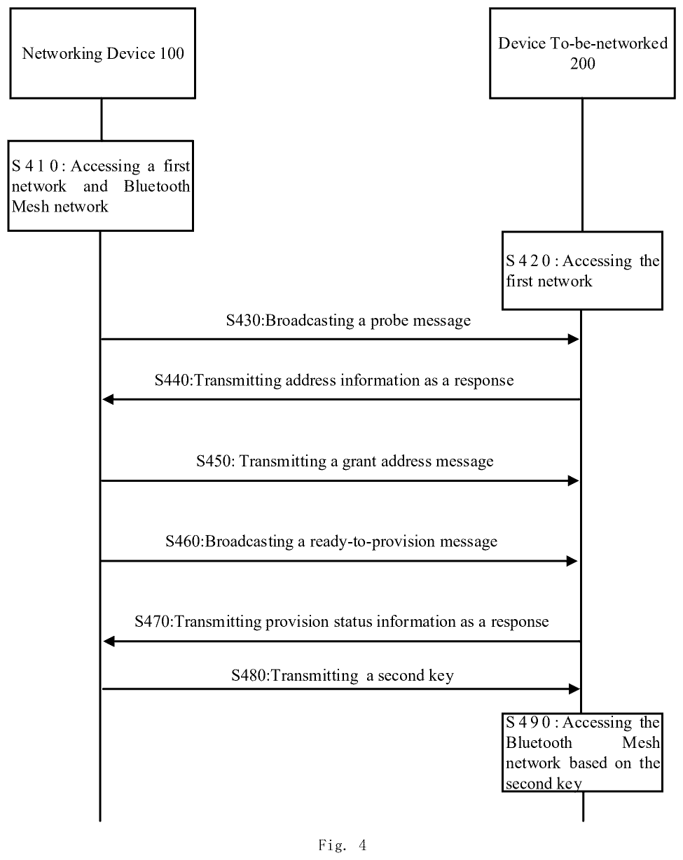

Having described the Bluetooth Mesh networking method according to an embodiment of the present disclosure above, exemplary operations of the networking device and the device to-be-networked in the Bluetooth Mesh networking method according to an embodiment of the present disclosure are described below with reference to FIG. 4. In the example shown in FIG. 4, the networking process is divided into three stages as follows:

Stage 1: The device to-be-networked enters the first network and the networking device performs inter-device conflicting address detection.

Stage 2: The device to-be-networked waits in the first network for the networking device to provision.

Stage 3: The device enters the formal network

Hereinafter, the flow of each stage will be described with reference to FIG. 4.

### Stage 1

Specifically, the first stage comprises the following steps:

In step S410, the networking device 100 is powered up which makes itself enter a first network and a second network directly, and more specifically, the first network may be a temporary Bluetooth Mesh network and the second network may be a formal Bluetooth Mesh network.

In step S420, after power-up of the device 200, the device 200 enters the first network using the first key held by itself, which may be a set of keys set by default at the time of manufacture as described above, and randomly generates and occupies a unicast address according to its MAC address. The first key may be in the form of temp_net_key and temp_app_key as described above.

In step S430, the networking device 100 broadcasts a probe message for probing devices to-be-networked in the first network in a timely manner, and the specific contents of the probe message may refer to the probe message as described above.

In step S440, the device to-be-networked listens to the probe message and replies in response to a device status message including address information after listening to the probe message, the specific contents of the device status message being referred to the device_status message as described above.

In one embodiment, the networking device 100 determines whether the address information is available based on the address information in the device status message.

In a further embodiment, the networking device 100 receives the device status device_status message from the device to-be-networked 200, either directly or via the relay device, and performs inter-device conflicting address detection based on the unicast address occupied by the device to-be-networked 200, i.e. confirms whether the unicast address currently occupied by the device to-be-networked is already occupied by any device already networked. The specific procedure of the inter-device collision address detection performed by the networking device is described above with reference to FIG. 3, and will not be described in detail here.

In the case where the networking device determines that the unicast address currently occupied by the device to-be-networked is available, it transmits a grant address message to the device to-be-networked in step S450, whereby the device to-be-networked enters two stages.

Notably, the relay devices (which may also be referred to as relay stations) referred to herein may be a device(s) already networked that is in the first network and/or the formal Bluetooth Mesh network, including a device(s) already networked in both the first network and the formal Bluetooth Mesh network, a device(s) only in the first network, and a device(s) only in the formal Bluetooth Mesh network, and thus may forward communication between the networking device and the device to-be-networked as relay devices, effectively extending the communication distance between the networking device and the device to-be-networked so that more distant devices may be detected and networked. Specifically, the device(s) in both the first network and the Bluetooth Mesh network may relay communication between the networking device and the device to-be-networked both under the first network and the Bluetooth Mesh network as a relay node, the device(s) only in the first network may act as a relay node relaying communication between the device to-be-networked and the networking device under the first network, while the device(s) only in the Bluetooth Mesh network may act as a relay node relaying communication between the device to-be-networked (and the devices already networked) and the networking device under the Bluetooth Mesh network.

### Stage 2

In particular, the second stage comprises the steps of:

In step S460, the networking device broadcasts a ready-to-provision message to collect information of devices ready to enter the formal Bluetooth Mesh network. The networking message may be the ready_ prov message as described above.

In step S470, the device 200 having entered the first network receives the ready-to-provision message and replies with a provision status message in response after being ready to enter the formal Bluetooth Mesh network. The provision status message may be the prov_status message as described above.

In one embodiment, the provision status message may include information regarding the distance between the networking device and the device to-be-networked and the number of message hops required for the message to be sent from the networking device to the device to-be-networked. Specifically, the specific content of the provision status message may be the prov_status message including RSSI and TTL described above,.

In step S480, the networking device 100 collects the provision status message of the device to-be-networked 200 entering the first network, thereby confirming that the current apparatus can be distributed, and transmits the second key thereto. In one embodiment, the second key may be included in the provision message, the detailed content of which may be referenced to the prov message described above.

In one embodiment, the networking device may also transmit the second key to the device to-be-networked 200 according to the determined provision priority. For example, the networking device may send the second key to the device to-be-networked in response to the provisioning priority of the device to-be-networked being higher than the provisioning priority(ies) of other device(s) to-be-networked.

In a more specific embodiment, the provisioning priority is determined based on at least one of a message indicating a distance between the device to-be-networked and the networking device and a number of hops required to transmit the message from the networking device to the device to-be-networked. For example, the provision priority may be calculated based on at least one of RSSI and TTL.

The method of transmitting the key for the formal Bluetooth Mesh network to the device to-be-networked based on the provision priority determined according to the distance and/or the number of message hops between the networking device and the device to-be-networked can enable devices relatively closer to the center of the topology to enter the formal network first, which guarantees the efficiency of initializing the provision parameters in the formal network, speeding up the overall provision flow. In addition, this way of networking also enables the device that enters a formal Bluetooth Mesh network to communicate more efficiently and stably during the gateway election process, ensuring that a more suitable, stable, and closer-to-center gateway can be found.

### Stage 3

In step S490, the device having entered the first network enters the formal Bluetooth Mesh network based on the second key received from the networking device, and enters three stages.

In particular, the device enters the formal network based on the second key in the received provisioning message and the available unicast address confirmed by the networking device.

At this point, the networking device and the device that has entered the formal Bluetooth Mesh network still have the keys of the first network, which enables them to simultaneously communicate with other devices that are also in either of the first network and the formal Bluetooth Mesh network.

It should be noted that the networking device is always in the temporary network and the formal network at the same time in the three stages, and the keys for both networks can be used respectively to decrypt, forward and process messages of these two networks. By doing this, the networking device can communicate with devices in both networks at the same time, ensuring networking efficiency while ensuring communication with the devices networked already.

Moreover, in the above three stages, the device to-be-networked and the networking device may be provided with a memory, which may be implemented as a register, for example, for holding configuration information related to the stage experienced between the two. Thus, even if an abnormal situation such as packet loss, power loss occurs midway, the networking device or the device to-be-networked can simply read the configuration from its memory for recovery, thereby improving networking efficiency.

In the above networking method, when a new device to-be-networked is powered on and enters the first network, since the new device enters the first network using its own key and the networking device is in both the first network and the Bluetooth Mesh network, the networking device instantly discovers and provisions the new device without performing network or key switching. In addition, since networked devices in the present disclosure can exist in both networks, they can act as relay devices to forward the content of the communication between the networking device and the new device to-be-networked, thereby effectively expanding the communicable distance between the networking device and the device to-be-networked, which is better compatible with a variety of scenarios, including a scenario in which only new remote devices are powered on or a scenario in which only a small number of more dispersed new devices are powered on.

By the above-described method of the present disclosure and the devices involved, at least one of the following technical effects can be achieved:
(1) remote networking is enabled, and thus the provisioner or networking device does not have to be within communication range of the device to be provisioned in the network (provisioning object or device to-be-networked);
(2) more flexible networking is enabled, since parameters to obtain specific provisioning information can be negotiated under their own protocol with subsequent stronger scalability, and required data can be customized in message fields;
(3) faster provision speed is enabled, since only three message interactions are required currently to provision one device from one stage to two stages to three stages, while an average delay of one interaction in one hop is 180 ms, i.e., it delays 540 ms in total to provision if 4 hops are needed, and simultaneous provision of multiple devices can be supported;
(4) The system composed of the above devices is more stable, and the information at each stage is stored in the memory of the devices. Even if there is an abnormal situation such as packet loss or power loss midway, the information in the memory can be read for recovery.

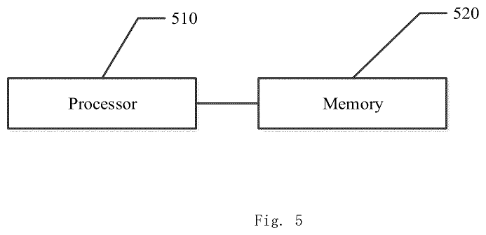

FIG. 5 is a block diagram of a device according to an embodiment of the present disclosure.

The device according to an embodiment of the present disclosure may be used to implement the networking device 100 or the device to-be-networked 200 in the present disclosure, wherein the device to-be-networked may be implemented as a Bluetooth device including at least one of a smart light system, a downlight, and a switch, and the networking device 100 may be implemented as a user-end control device, a user device software end, or the like. With reference to FIG. 5, a device according to the present disclosure comprises a processor 510 and a memory 520, wherein the memory 520 stores computer program which, when executed by the processor, causes the processor to perform a method as described in one or more of the various embodiments above. In one embodiment, the processor may be implemented as one or more processors, including general-purpose or special-purpose processors.

According to an embodiment of the present disclosure, there may further be provided a computer-readable storage medium storing computer program, wherein the computer program, when executed by at least one processor, causes the at least one processor to perform any one of the above-described methods according to exemplary embodiments of the present disclosure. Examples of the computer readable storage medium herein include a read only memory (ROM), a random access programmable read only memory (PROM), an electrically erasable programmable read only memory (EEPROM), a random access memory (RAM), a dynamic random access memory (DRAM), a static random access memory (SRAM), a flash memory, a non-volatile memory, a CD-ROM, a CD−R, a CD+R, a CD−RW, a CD+RW, a DVD-ROM, a DVD−R, a DVD+R, a DVD−RW, a DVD+RW, a DVD-RAM, a BD-ROM, a BD-R, a BD-R LTH, a BD-RE, a Blu-ray or optical disk memory, a hard disk drive (HDD), a solid state hard disk (SSD), a card type memory such as a multimedia card, a secure digital (SD) card, or an extreme digital (XD) card, a magnetic tape, a floppy disk, a magneto-optical data storage device, an optical data storage device, a hard disk, a solid state disk, and any other device configured to store the computer program and any associated data, data files and data structures in a non-transitory manner and to provide the computer program and any associated data, data files and data structures to the processor or computer so that the processor or computer can execute the computer program. The instructions in the computer-readable storage media or computer program described above may be executed in an environment deployed in computer equipment such as clients, hosts, agent devices, servers, etc. Furthermore, in one example, the computer program and any associated data, data files, and data structures are distributed over a networked computer system so that the computer program and any associated data, data files, and data structures are stored, accessed, and executed in a distributed fashion by one or more processors or computers.

Those of skill in the art will appreciate that the above illustrative embodiments are described herein and are not intended to be limiting. It should be understood that any two or more of the embodiments disclosed herein may be combined in any combination. Further, other embodiments may be utilized, and other changes may be made, without departing from the spirit and scope of the subject matter presented herein. It will be readily understood that the aspects of the invention of the present disclosure, as generally described herein, and illustrated in the figures, can be arranged, substituted, combined, separated, and designed in a wide variety of different configurations, all of which are contemplated herein.

Those of skill in the art will appreciate that the various illustrative logical blocks, modules, circuits, and steps described herein may be implemented as hardware, software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such design decisions should not be interpreted as causing departure from the scope of the present application.

The various illustrative logical blocks, modules, and circuits described herein may be implemented or performed with a general-purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in an alternative implementation, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described herein may be embodied directly in hardware, in a software module executed by a processor, or in a combination of the two. A software module may reside in a RAM memory, flash memory, ROM memory, EPROM memory, EEPROM memory, registers, hard disk, a removable disk, or any other form of storage medium known in the art. An exemplary storage medium is coupled to the processor so that the processor can read information from, and write information to, the storage medium. In an alternative implementation, the storage medium may be integral to the processor. The processor and the storage medium may reside in an ASIC. The ASIC may reside in a user terminal. In an alternative implementation, the processor and the storage medium may reside as discrete components in a user terminal.

In one or more exemplary designs, the functions described may be implemented in hardware, software, firmware, or any combination thereof. If implemented in software, the functions may be stored or transmitted over as one or more instructions or code on a computer-readable medium. Computer-readable media includes both computer storage media and communication media including any medium that facilitates transfer of computer program from one place to another. A storage medium may be any available medium that can be accessed by a general purpose or special purpose computer.

The foregoing is merely an exemplary implementation of the present application and is not intended to limit the scope of protection of the present application, which is defined by the appended claims.

What is claimed is:

1. A Bluetooth Mesh network networking method, comprising:
accessing a first network, by a device to-be-networked, based on a first key;
receiving, from a networking device via the first network, a second key for accessing the Bluetooth mesh network; and
accessing the Bluetooth mesh network based on the second key,
wherein the networking device is in both the first network and the Bluetooth Mesh network.

2. The method of claim 1, wherein a device(s) in the first network and/or the Bluetooth Mesh network relays communication between the networking device and the device to-be-networked.

3. The method of claim 1, further comprising:
after accessing the Bluetooth Mesh network, the device to-be-networked remains in the first network.

4. The method of claim 1, further comprising:
transmitting address information of the device to-be-networked to the networking device via the first network, wherein the address information of the device to-be-networked includes a unicast address of the device to-be-networked.

5. The method of claim 4, further comprising:
the device to-be-networked retransmits the unicast address to the networking device in response to receiving a message for changing its unicast address from the networking device.

6. The method of claim 4, further comprising:
in case a message confirming its unicast address is received from the networking device, transmitting at least one of received signal strength indication (RSSI) and time-to-live (TTL) of the device to-be-networked to the networking device in response to receiving a ready-to-provision message.

7. The method of claim 6, further comprising:
storing the information communicated with the networking device in a memory of the device to-be-networked; and
reading the information from the memory for resuming communication in case of an interruption of communication with the networking device.

8. A Bluetooth Mesh network networking method, comprising:
receiving address information of a device to-be-networked, by a networking device, from the device to-be-networked accessing a first network based on a first key;
determining whether the address information is available for the device to-be-networked; and
transmitting, to the device to-be-networked, a second key for accessing the Bluetooth Mesh network via the first network in response to the address information being available for the device to-be-networked,
wherein the networking device is in both the first network and the Bluetooth Mesh network.

9. The method of claim 8, wherein a device(s) in the first network and/or the Bluetooth Mesh network relays communication between the networking device and the device to-be-networked.

10. The method of claim 8, wherein transmitting, to the device to-be-networked, the second key for accessing the Bluetooth Mesh network further comprises:
determining a priority of the device to-be-networked based on at least one of a distance of the networking device from the device to-be-networked and a number of hops required to send a message from the networking device to the device to-be-networked; and
transmitting the second key to the device to-be-networked in response to the priority of the device to-be-networked being higher than priority(ies) of other device(s) to-be-networked.

11. The method of claim 10, wherein the distance of the networking device from the device to-be-networked is indicated by received signal strength indication (RSSI) received from the device to-be-networked; and
the number of hops required to send a message from the networking device to the device to-be-networked is indicated by time-to-live (TTL) received from the device to-be-networked.

12. The method of claim 11, wherein the priority is determined by weighted summation of the RSSI and the TTL.

13. The method of claim 8, wherein the address information of the device to-be-networked comprises a unicast address of the device to-be-networked, and
wherein the method further comprises:
transmitting a message to the device to-be-networked acknowledging the unicast address, in response to the unicast address being available for the device to-be-networked.

14. The method of claim 13, further comprising:
transmitting a message for changing the unicast address to the device to-be-networked in response to the unicast address being unavailable for the device to-be-networked.

15. The method of claim 14, further comprising:
storing, in a memory of the networking device, the information communicated with the device to-be-networked; and
reading the information from the memory for resuming communication in case of interruption of communication with the device to-be-networked.

16. A Bluetooth device comprising:
a processor; and
a memory having stored thereon computer program which, when executed by the processor, causes the processor to perform a method as claimed in claim 1.

17. The device of claim 16, wherein the Bluetooth device comprises at least one of a smart light system, a downlight, and a switch.

18. A device for Bluetooth Mesh network networking, comprising:
a processor; and
a memory having stored thereon computer program which, when executed by the processor, causes the processor to perform a method as claimed in claim 8.

19. A non-transitory computer-readable storage medium having stored thereon computer programs which, when executed by a processor, cause the processor to perform the method according to claim 8.
